(19) United States
(12) Patent Application Publication
(10) Pub. No.: US 2025/0338012 A1
(43) Pub. Date: Oct. 30, 2025

(54) CONTROL APPARATUS, CONTROL METHOD, AND RECORDING MEDIUM

(71) Applicant: CANON KABUSHIKI KAISHA, Tokyo (JP)

(72) Inventor: YUICHI KINOSHITA, Kanagawa (JP)

(21) Appl. No.: 19/188,832

(22) Filed: Apr. 24, 2025

(30) Foreign Application Priority Data
Apr. 26, 2024 (JP) 2024-072444

(51) Int. Cl. H04N 23/661; H04N 23/65

(52) U.S. Cl. CPC H04N 23/661; H04N 23/651

(57) ABSTRACT

A control apparatus that controls an external device includes one or more processors and a memory storing instructions. The instructions, when executed by the one or more processors, cause the control apparatus to acquire recovery availability information indicating whether or not an external device is able to recover from a power-saving state to an active state using a Wake-on-LAN packet, and generate, in a case where a transition operation for causing the external device to transition from the active state to the power-saving state is performed using the Wake-on-LAN packet, notification information indicating that the external device is unable to recover to the active state, based on the recovery availability information acquired from the external device and indicating that the external device is unable to recover to the active state.

### BACKGROUND

### Field of the Disclosure

The present disclosure relates to a control apparatus, a control method, and a recording medium.

### Description of the Related Art

In recent years, photographers have captured a wide variety of competition scenes at sporting events such as the Olympics, and many of the photos taken have been distributed in media news. Multiple photographers are needed to shoot various scenes, which results in numerous labor and other costs.

A system is known that controls each camera from a computer connected to multiple cameras via a network (Japanese Patent Laid-Open No. 2023-9896).

The use of such a system makes it possible to reduce the number of photographers. Furthermore, the reduction in the number of photographers will reduce costs and enable a large number of images to be captured in various compositions. Note that Nikon's NX Field® and SONY's Remote Camera Tool®, for example, can be used as a remote shooting system that can remotely perform shooting control of multiple digital cameras.

In such a remote shooting system, in a case where images of sporting events are to be captured in various compositions, many cameras may be installed near the finish line to capture images of track events, for example. In such cases, the cameras installed remotely may remain in place. For example, the cameras may be left to perform remote shooting for long periods of time or may be left on standby for long periods of time, depending on the schedule of athletes as the subject of the cameras.

In addition, depending on the location where the cameras are installed, it may be necessary to cover the cameras with a rain cover, or to avoid situations where the camera bodies are exposed to direct sunlight outdoors and the temperatures of the camera bodies rise. In addition, it may be necessary to operate the cameras using the main units' batteries without using external power sources. This creates the need to remotely turn the cameras on and off, for example, to reduce heat rise in the camera bodies and battery consumption by turning off the cameras.

Thus, there may be cases where multiple digital cameras are controlled by a control apparatus through a remote shooting control application (hereinafter referred to as “multi-remote application”) running on the control apparatus via a network. The use of the multi-remote application allows remote camera power control by remotely issuing a power-off (sleep) command and performing power-on control using Wake-on-LAN (hereafter referred to as “WOL”).

However, problems can occur when a control apparatus turns on a digital camera, such as the inability to activate the digital camera depending on the network function of the digital camera's communication unit or the network configuration. In such a situation, once the control apparatus remotely turns off the digital camera, the digital camera cannot be activated remotely and the user may miss shooting scenes.

### SUMMARY

Thus, the present disclosure provides techniques and embodiments that make it possible to recognize, before turning off a digital camera, that the digital camera may be in a situation where the digital camera cannot be turned on remotely using WOL.

In some embodiments, the present disclosure provides a control apparatus that controls an external device, the control apparatus including one or more processors and a memory storing instructions. The instructions, when executed by the one or more processors, cause the control apparatus to acquire recovery availability information indicating whether or not an external device is able to recover from a power-saving state to an active state using a Wake-on-LAN packet, and generate, in a case where a transition operation for causing the external device to transition from the active state to the power-saving state is performed using the Wake-on-LAN packet, notification information indicating that the external device is unable to recover to the active state, based on the recovery availability information acquired from the external device and indicating that the external device is unable to recover to the active state.

Further features of various embodiments will become apparent from the following description of exemplary embodiments (with reference to the attached drawings).

### BRIEF DESCRIPTION OF THE DRAWINGS

FIG. 1A is a hardware configuration diagram illustrating the configuration of a digital camera, and FIGS. 1B and 1C are diagrams illustrating the appearance of the digital camera.

FIG. 2 is a hardware configuration diagram illustrating the configuration of a control apparatus.

FIG. 3A is a system configuration diagram illustrating the configuration of remote control performed between the control apparatus and multiple digital cameras connected thereto with a network device interposed therebetween, and FIG. 3B is a system configuration diagram illustrating an example of a network connection.

FIGS. 4A to 4D are diagrams illustrating, using a track event as an example, a scene where a photographer applies multi-remote shooting, and a network configuration of multi-remote shooting.

FIGS. 5A to 5C illustrate an example of a screen that is displayed on a display unit of the control apparatus and through which the shooting of two digital cameras connected to the control apparatus is controlled.

FIGS. 6A and 6B are flowcharts illustrating a focus drive control process that the control apparatus performs on each of multiple digital cameras connected thereto during multi-remote shooting.

FIG. 7 is a flowchart illustrating a process in which the digital camera receives a command from the connected control apparatus and performs remote shooting.

FIGS. 8A and 8B illustrate an example of a screen illustrating a top screen, which is the entry point to an application that registers cameras, sets group control settings, and sets the function of each camera in the control apparatus.

FIGS. 9A to 9C illustrate a screen for the control apparatus to perform a power control operation on and set settings for the digital camera, and FIG. 9D illustrates an example of the configuration of a packet to be transmitted to the digital camera when a power control command is issued.

FIG. 10 is a power control processing sequence diagram in which the control apparatus establishes a connection with the digital camera, sets a WOL setting, and thereafter turns off and then on the digital camera, and reconnects to the digital camera.

FIG. 11 is a flowchart illustrating a process in which, when the control apparatus turns off the digital camera, the control apparatus determines the network status of the digital camera, determines that the digital camera is in a situation where the digital camera cannot be turned on, and performs warning display for the user of the control apparatus.

FIG. 12A illustrates a multi-remote shooting screen of a multi-remote application running on the control apparatus when an error occurs in the digital camera during multi-remote shooting, and FIG. 12B illustrates an example of an error message to the user displayed on the display unit of the digital camera.

FIGS. 13A to 13C illustrate examples of screens for the control apparatus to perform a power control operation on and sets settings and resets settings for the digital camera in a case where a reset function of the digital camera is enabled.

FIG. 14 is a reset control sequence diagram in which the control apparatus establishes a connection with the digital camera, then sets a WOL reset setting, performs a reset process after an error occurs in the digital camera, and reconnects to the digital camera.

FIG. 15 is a flowchart illustrating a process in which, when setting a WOL reset setting for the digital camera, the control apparatus determines the network status of the digital camera, determines that the digital camera is in a situation where the digital camera cannot be reset and reactivated, and performs warning display for the user of the control apparatus.

### DESCRIPTION OF THE EMBODIMENTS

In the following, example embodiments for implementing the present disclosure will be described in detail using the attached drawings.

Note that the example embodiments described below are examples as ways of realizing the present disclosure and may be modified or changed as appropriate depending on the configurations and various conditions of apparatuses to which the present disclosure is applied. Embodiments can be combined as appropriate.

### First Embodiment

In a first embodiment, a case is assumed in which a control apparatus 200 remotely transmits a power-off communication command to digital cameras 100 connected to the control apparatus 200 for multi-remote shooting. The control apparatus 200 according to the present embodiment determines the settings and conditions that prevent the digital camera 100 from being turned on (namely, that prevent the digital camera 100 from returning to its active state) when each digital camera 100 is turned off. The following will describe an Example in which the control apparatus 200 displays a warning and a message to the user and an Example in which the control apparatus 200 transmits a WOL packet 930 and turns on the digital camera 100.

### Configuration of Digital Camera 100

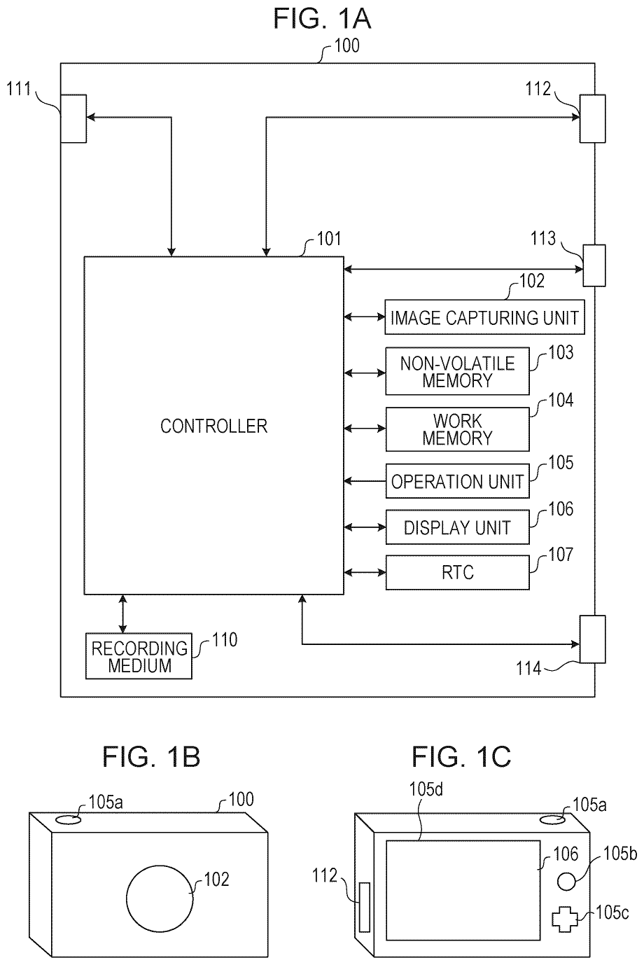

FIG. 1A is a hardware configuration diagram illustrating an example of the configuration of the digital camera 100, which is an example of a communication device according to the present embodiment. Note that although a digital camera is described in this case as an example of the communication device, the communication device is not limited to this. For example, the communication device may be a portable media player or an information processing device, such as a so-called tablet device or a personal computer.

A controller 101 controls various units of the digital camera 100 in accordance with input signals or programs described below. Note that instead of the controller 101 controlling the entire apparatus, the entire apparatus may be controlled by multiple hardware devices sharing the process.

An image capturing unit 102 is constituted by, for example, an optical lens unit, an optical system for controlling aperture, zoom, and focus, and an image capturing device for converting light (images) introduced through the optical lens unit into an electrical image signal. As the image capturing device, generally, a complementary metal-oxide-semiconductor (CMOS) or a charge-coupled device (CCD) is used. By being controlled by the controller 101, the image capturing unit 102 converts, using the image capturing device, subject light brought into focus by the lenses included in the image capturing unit 102 into an electrical signal, performs noise reduction processing, for example, and outputs digital data as image data. In the digital camera 100 according to the present embodiment, the image data is recorded on a recording medium 110 in accordance with Design Rule for Camera File System (DCF).

A non-volatile memory 103 is a non-volatile memory that can be electrically erased and recorded, and stores programs, for example, described below that are executed by the controller 101.

A work memory 104 is used as a buffer memory to temporarily hold image data captured by the image capturing unit 102, as a memory for displaying images on a display unit 106, and as, for example, a work area for the controller 101.

An operation unit 105 is used to accept the user's instructions to the digital camera 100 from the user. The operation unit 105 includes, for example, a power button for the user to issue a power-on/off instruction for the digital camera 100, a release switch for the user to issue a shooting instruction, and a playback button for the user to issue an playback instruction for image data. Furthermore, the operation unit 105 includes operation components, such as a dedicated connection button to initiate communication with external devices via a communication unit 111 described below. Moreover, the operation unit 105 also includes a touch panel formed in the display unit 106 described below. Note that the release switch has SW1 and SW2. SW1 is turned ON when the release switch is in a so-called half-pressed state. This accepts instructions to prepare for shooting, such as autofocus (AF) processing, automatic exposure (AE) processing, automatic white balance (AWB) processing, and flash preliminary emission (EF) processing. SW2 is turned ON when the release switch is in a so-called fully-pressed state. This accepts instructions for shooting.

The display unit 106 displays a viewfinder image during shooting, displays captured images, and displays text for interactive operation. Note that the display unit 106 does not necessarily have to be built into the digital camera 100. The digital camera 100 can be connected to an internal or external display unit 106, and it is sufficient that the digital camera 100 have at least a display control function to control display on the display unit 106.

A Real-Time Clock (RTC) 107 performs clock management. The time may be set by the user using the operation unit 105, may be set by acquiring time information via the communication unit 111, or may be acquired and set by a radio clock. It is sufficient that the RTC 107 can manage the time.

The recording medium 110 can record image data output from the image capturing unit 102.

The recording medium 110 may be configured to be removable from the digital camera 100 or may be built into the digital camera 100. That is, it is sufficient that the digital camera 100 have at least a unit to access the recording medium 110.

The communication unit 111 is an interface for connecting to external devices. The digital camera 100 according to the present embodiment can exchange data with external devices via the communication unit 111. For example, image data generated by the image capturing unit 102 can be transmitted to external devices via the communication unit 111. Note that in the present embodiment, the communication unit 111 includes an interface for communicating with external devices through a so-called wireless LAN according to the IEEE 802.11 standard. The controller 101 controls the communication unit 111 to achieve wireless communication with external devices. Note that the communication method is not limited to wireless LAN and includes, for example, infrared communication methods.

The communication unit 111 is an example of a first wireless communication unit.

A communication unit 112 is an interface for connecting to external devices. The digital camera 100 according to the present embodiment can exchange data with external devices via the communication unit 112. For example, the image data generated by the image capturing unit 102 can be transmitted to external devices via the communication unit 112. Note that in the present embodiment, the communication unit 112 includes an interface for communicating with external devices through so-called Bluetooth® according to the IEEE 802.15.1 standard. The controller 101 controls the communication unit 112 to achieve wireless communication with external devices. Note that the communication method is not limited to Bluetooth and includes, for example, wireless LAN known as the IEEE 802.11 standard or infrared communication methods. The communication unit 112 is an example of the first wireless communication unit.

A communication unit 113 is an interface for connecting to external devices. The digital camera 100 according to the present embodiment can exchange data with external devices via the communication unit 113. For example, the image data generated by the image capturing unit 102 can be transmitted to external devices via the communication unit 113. Note that in the present embodiment, the communication unit 113 includes an interface for communicating with external devices through a wired LAN (Ethernet) according to the IEEE 802.3 standard. The controller 101 controls the communication unit 113 to achieve communication with external devices. Note that the communication method is not limited to wired LAN and includes, for example, USB communication methods. The communication unit 113 is an example of a first wired communication unit.

Note that the communication unit 112 of the digital camera 100 in the present embodiment has either a peripheral mode or a central mode. By operating the communication unit 112 in the peripheral mode, the digital camera 100 in the present embodiment can operate as a client device in Bluetooth. In a case where the digital camera 100 operates as a client device, the digital camera 100 can communicate by connecting to an external device that is in the central mode. For authentication with an external device to be connected, pairing performed in advance allows the non-volatile memory 103 to hold unique information of the external device to be connected. In addition, even when a power switch (SW) is in an off state, the digital camera 100 can sends signals in a case where power is supplied to a Bluetooth module.

A proximity wireless communication unit 114 includes, for example, an antenna for wireless communication and a modulation-demodulation circuit for processing wireless signals, and a communication controller. The proximity wireless communication unit 114 outputs modulated wireless signals from the antenna and demodulates wireless signals received by the antenna. This enables contactless proximity communication according to the ISO/IEC 18092 standard (near-field communication (NFC)). The proximity wireless communication unit 114 in the present embodiment is arranged on the side of the digital camera 100.

The digital camera 100 is connected to and starts communication with the control apparatus 200 described below by bringing the proximity wireless communication unit 114 and a proximity wireless communication unit 214 of the control apparatus 200 to close to each other. In a case where the digital camera 100 is connected to the control apparatus 200 using the proximity wireless communication unit 114, the proximity wireless communication unit 114 and the proximity wireless communication unit 214 do not necessarily have to be in contact with each other. The proximity wireless communication units 114 and 214 can communicate with each other even if they are separated by a certain distance. Thus, it is sufficient that the proximity wireless communication units 114 and 214 be brought close to each other so that the proximity wireless communication units 114 and 214 are within a range where proximity wireless communication is possible. In the following description, bringing these proximity wireless communication units close to each other so that these proximity wireless communication units are within this range where proximity wireless communication is possible is also referred to as bringing them into close proximity.

Next, the appearance of the digital camera 100 will be described. FIGS. 1B and 1C are diagrams illustrating the appearance of the digital camera 100. A release switch 105a, a playback button 105b, a direction key 105c, and a touch panel 105d are operation components included in the above-mentioned operation unit 105. The display unit 106 displays an image obtained as a result of image capturing performed by the image capturing unit 102. The digital camera 100 in the present embodiment has an antenna portion of a power supply unit (the communication unit 112) on the side of the camera housing. By bringing these power supply units 112 close to each other so that these power supply units 112 are within a certain distance, power can be supplied. This enables contactless power supply without using cables, for example, and can also control the start and end of power supply.

The above is a description of the digital camera 100.

Digital Camera Power Supply Control through LAN

In a case where the communication unit 113 of the digital camera 100 is connected to a wired LAN, the controller 101 controls settings for a wired LAN communication unit of the communication unit 113. When the power of the digital camera 100 is turned off, the controller 101 receives a LAN communication command from the control apparatus 200, which is an external apparatus, and sets settings regarding whether or not power activation of the digital camera 100 is possible.

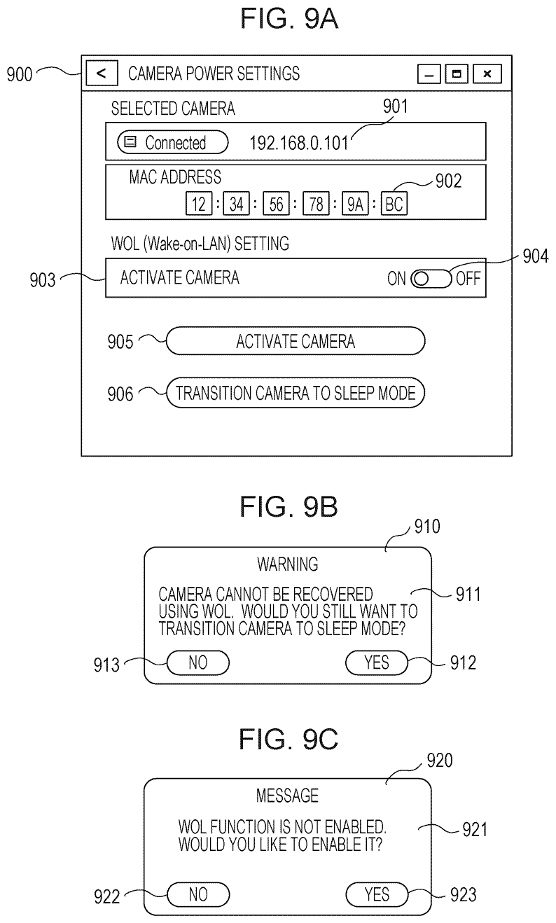

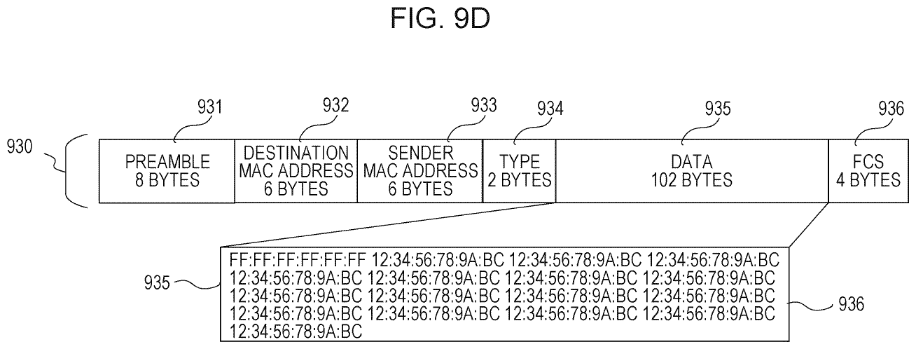

For example, when the digital camera 100 is in the power-off state and power activation is set to enabled, the digital camera 100 receives a WOL packet 930, illustrated in FIG. 9D, transmitted from the external control apparatus 200 via UDP broadcast communication. This causes the communication unit 113, which is connected to a wired LAN, to input an interrupt signal into the controller 101 of the digital camera 100, and the power of the digital camera 100 is then activated.

When a connection is established between the external control apparatus 200 and the digital camera 100 through TCP/IP communication, the digital camera 100 turns off its power when receiving a power-off command from the external control apparatus 200.

### Internal Configuration of Control Apparatus 200

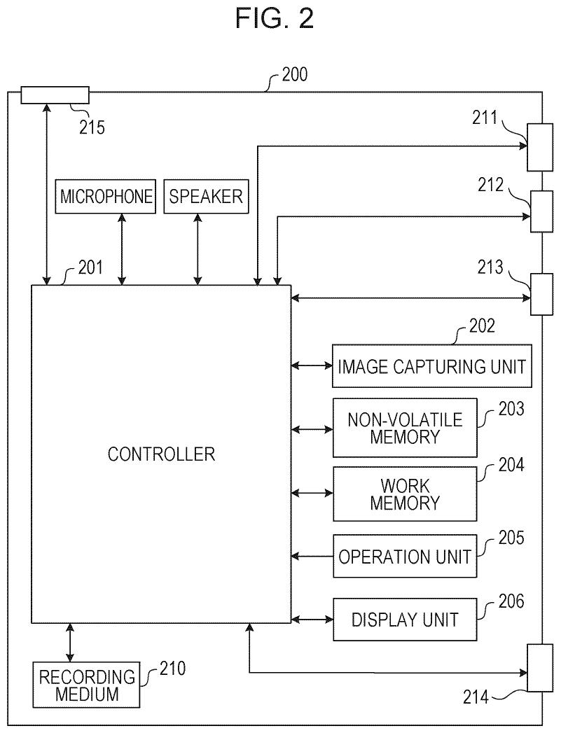

FIG. 2 is a hardware configuration diagram illustrating an example of the configuration of the control apparatus 200, which is an example of the information processing device, according to the present embodiment. Note that although the control apparatus is described in this case as an example of the information processing device, the information processing device is not limited to this. For example, the information processing device may be a digital camera, tablet device, or personal computer with wireless capabilities.

A controller 201 controls various units of the control apparatus 200 in accordance with input signals or programs described below. Note that instead of the controller 201 controlling the entire apparatus, the entire apparatus may be controlled by multiple hardware devices sharing the process.

A non-volatile memory 203 is a non-volatile memory that can be electrically erased and recorded. The non-volatile memory 203 records an operating system (OS), which is the basic software executed by the controller 201, and applications that work with this OS to achieve applied functions. In the present embodiment, the non-volatile memory 203 stores applications (hereinafter referred to as “apps”) for communicating with the digital cameras 100.

A work memory 204 is used as a memory for displaying images on a display unit 206 and as, for example, a work area for the controller 201.

An operation unit 205 is used to accept instructions to the control apparatus 200 from the user. The operation unit 205 includes, for example, a power button for the user to turn the control apparatus 200 on or off, an operation component to set settings for an RTC 207, and an operation component such as a touch panel formed on the display unit 206.

The display unit 206 displays captured images and displays text for interactive operation. Note that the display unit 206 does not necessarily have to be included in the control apparatus 200. It is sufficient that the control apparatus 200 can be connected to the display unit 206 and have at least a display control function to control display on the display unit 206.

The RTC 207 performs clock management. The time may be set by the user using the operation unit 205, may be set by acquiring time information via a communication unit 211, a communication unit 212, or a public network connection unit 215, or may be acquired and set by a radio clock. It is sufficient that the RTC 207 can manage the time. The time may also be obtained by a mechanism for detecting time from a mechanical mechanism such as an analog clock (in this case, assume that the RTC 207 includes the mechanism for detecting time from the analog clock).

A recording medium 210 can record image data transferred by the digital camera 100 to the controller 201 via the communication unit 211. The recording medium 210 may be configured to be removable from the control apparatus 200 or may be built into the control apparatus 200. That is, it is sufficient that the control apparatus 200 have at least a unit to access the recording medium 210.

The communication unit 211 is an interface for connecting to external devices. The control apparatus 200 according to the present embodiment can exchange data with external devices via the communication unit 211. In the present embodiment, the communication unit 211 is an antenna, and the controller 201 can be connected to the digital cameras 100 via the antenna. Note that in the present embodiment, the communication unit 211 includes an interface for communicating with external devices through a so-called wireless LAN according to the IEEE 802.11 standard. The controller 201 controls the communication unit 211 to achieve wireless communication with external devices. Note that the communication method is not limited to wireless LAN and includes, for example, infrared communication methods. The communication unit 211 is an example of the first wireless communication unit.

The communication unit 212 is an interface for connecting to external devices. The control apparatus 200 according to the present embodiment can exchange data with external devices via the communication unit 212. For example, the image data generated by the digital cameras 100 can be received via the communication unit 212. Note that in the present embodiment, the communication unit 212 includes an interface for communicating with external devices through so-called Bluetooth® according to the IEEE 802.15.1 standard. The controller 201 controls the communication unit 212 to achieve wireless communication with external devices. Note that the communication method is not limited to Bluetooth and includes, for example, a wireless LAN known as the IEEE 802.11 standard or infrared communication methods. The communication unit 212 is an example of the first wireless communication unit.

A communication unit 213 is an interface for connecting to external devices. The control apparatus 200 according to the present embodiment can exchange data with external devices via the communication unit 213. For example, the image data generated by the digital cameras 100 can be received via the communication unit 213. Note that in the present embodiment, the communication unit 213 includes an interface for communicating with external devices through a wired LAN (Ethernet) according to the IEEE 802.3 standard. The controller 201 controls the communication unit 213 to achieve wireless communication with external devices. Note that the communication method is not limited to wired LAN and includes, for example, USB communication methods. The communication unit 213 is an example of the first wired communication unit.

Note that the communication unit 212 of the control apparatus 200 according to the present embodiment has either the peripheral mode or the central mode. By operating the communication unit 212 in the central mode, the control apparatus 200 according to the present embodiment can operate as a Bluetooth server device. In a case where the control apparatus 200 operates as a server device, the control apparatus 200 can communicate by connecting to an external device that is in the peripheral mode. For authentication with an external device to be connected, pairing performed in advance allows the non-volatile memory 203 to hold unique information of the external device to be connected.

The proximity wireless communication unit 214 includes, for example, an antenna for wireless communication and a modulation-demodulation circuit for processing wireless signals, and a communication controller. The proximity wireless communication unit 214 outputs modulated wireless signals from the antenna and demodulates wireless signals received by the antenna. This enables contactless proximity communication according to the ISO/IEC 18092 standard (NFC). The proximity wireless communication unit 214 in the present embodiment is arranged on the side of the control apparatus 200.

### System Configuration Diagram

Next, a system configuration diagram according to the present embodiment will be described.

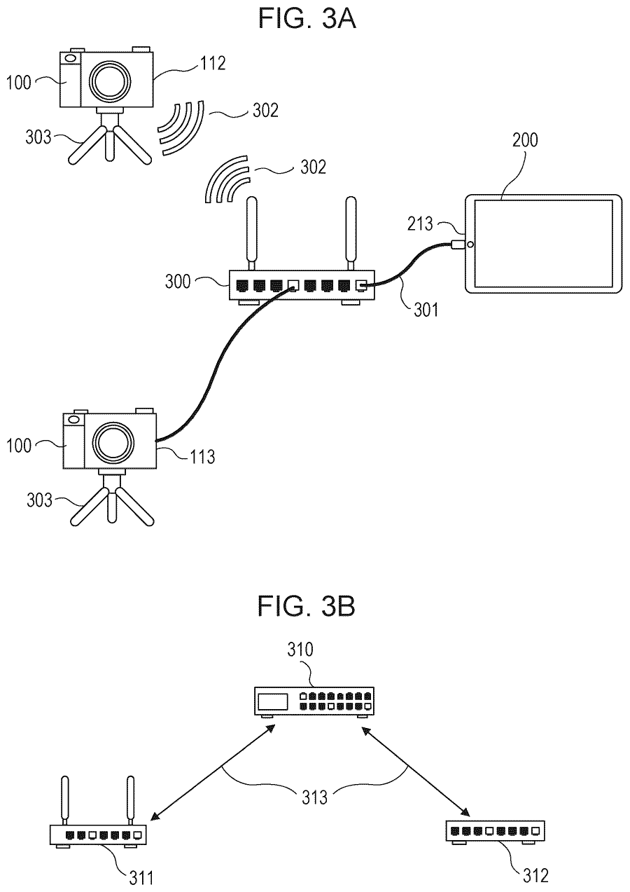

FIG. 3A is a system configuration diagram in which the control apparatus 200 performs remote control of multiple digital cameras 100, which are connected to the control apparatus 200 with a network device 300 interposed therebetween.

The digital cameras 100 are mounted on tripods 303, for example, and are installed at respective shooting positions. Note that in this Example, the digital cameras 100 are mounted on the tripods 303; however, the digital cameras 100 may be mounted on remote pan heads on which pan, tilt, and zoom control can be remotely performed.

Examples of connection forms between each digital camera 100 and the control apparatus 200 in communication will be listed below. For example, the digital camera 100 may communicate with the control apparatus 200 through the communication unit 112 in wireless communication using radio waves 302 via the network device 300 serving as a relay. In addition, the digital camera 100 may communicate with the control apparatus 200 through the communication unit 113 using a wired LAN cable 301 via the network device 300.

The control apparatus 200 may also communicate with the digital camera 100 through the communication unit 212 in wireless communication using the radio waves 302 via the network device 300 serving as a relay. The control apparatus 200 may also communicate with the digital camera 100 through the communication unit 213 using a wired LAN via the network device 300.

Note that although examples in which communication is performed via the network device 300 have been described in this Example, the digital camera 100 and the control apparatus 200 may be directly connected to each other.

As illustrated in FIG. 3A, in a state where the multiple mounted digital cameras 100 and the control apparatus 200 can communicate with each other, the control apparatus 200 can issue a command to each digital camera 100 to acquire setting information regarding the digital camera 100 and change the settings.

Furthermore, the control apparatus 200 can issue a shooting command and a command as to whether or not the focus is driven accordingly, so that the control apparatus 200 can issue a shooting instruction remotely.

Furthermore, as illustrated in FIG. 3B, the network device 300 may be connected, in multiple stages, to a network device 311 and a network device 312 through communication paths 313 via a network device 310 serving as a hub. This can extend the communication distance, and a network system that connects remote locations to each other can be configured. Note that, for example, the wired LAN cable 301, the radio waves 302, and USB cables may be used in the network used for the communication paths 313.

### Multi-Remote Shooting in Track Events

Next, this Example will describe subject composition examples and shooting situations regarding the focus setting during shooting in a case where shooting control is performed on multiple digital cameras 100 installed in a sports stadium 410 (hereinafter referred to as “multi-remote shooting”). Furthermore, a system configuration and an installation example of the digital cameras 100, control apparatus 200, and network device 300 in multi-remote shooting will be described below.

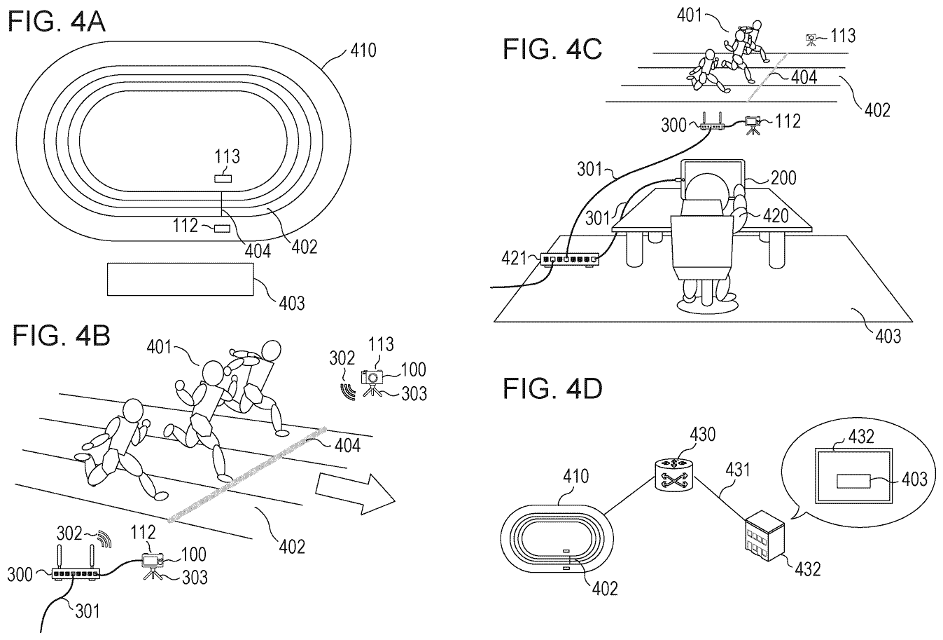

FIGS. 4A to 4C are diagrams illustrating, using track event shooting as an example, a photographer and a method for installing multiple digital cameras 100 in multi-remote shooting, and FIG. 4D is a diagram illustrating an example of the configuration of a network for remotely controlling the digital cameras 100.

As illustrated in FIG. 4A, the multiple digital cameras 100, which are a first digital camera 112 and a second digital camera 113, are installed near a goal 404 of a track 402 in the sports stadium 410. Furthermore, a shooting area 403 where a photographer can perform multi-remote shooting is provided.

In a case where images of a goal scene of subjects 401, which are shooting targets, are to be captured, images of the subjects 401 are captured from different angles so as not to miss the decisive moment. For example, to capture images of as many athletes as possible, the first digital camera 112 and the second digital camera 113 are arranged on both sides of the goal 404 as illustrated in FIG. 4B.

The first digital camera 112 is connected to the network device 300 through a wired LAN connection. The second digital camera 113 is located on the inner side, but outside the track 402, and the subjects 401 run on the track. Thus, a wired LAN connection through the wired LAN cable 301 that obstructs the athletes' running cannot be used between the second digital camera 113 and the network device 300. Thus, the second digital camera 113 has a wireless LAN connection with the network device 300, and shooting control is performed using the radio waves 302.

Furthermore, regarding the power supply to the digital cameras 100, since the first digital camera 112 is installed on the outer side of the track 402, it can be assumed that an external power supply device together with an AC adapter and a DC coupler is used for power supply. In contrast, the second digital camera 113 is installed on the inner side of the track 402, and thus it can be assumed that a battery is used to supply power.

The shooting area 403, which is located at a position away from the competition area of the track 402 as illustrated in FIG. 4C, will be described. In the example illustrated in FIG. 4C, a photographer 420 captures, from a remote location, images of the subjects 401 by performing shooting control of the first digital camera 112 and the second digital camera 113 by operating the control apparatus 200. The photographer 420 may determine the timing to capture images while checking the competition of the subjects 401 or performs shooting while watching remote live-view images from the digital cameras 100 displayed on the control apparatus 200.

Moreover, a network device 421 in FIG. 4C may be networked to a location outside the stadium. As illustrated in FIG. 4D, the network device 421 may be connected to a press center 432 via a network device 430 outside the sports stadium 410, and a shooting area 403 similar to that of the sports stadium 410 may be provided in the press center 432. In this case, shooting control can be performed on the first digital camera 112 and the second digital camera 113 in the sports stadium 410 from the press center 432 through a communication network 431.

Note that for the network device 430, a router, an L3 switch, a repeater, or other network devices may be used. A major network infrastructure may be used to enable data communication between different locations, each of which may be interconnected via the Internet or a dedicated Wide Area Network (WAN). The communication network 431 between the locations may be connected using a virtual private network (VPN).

During a track event, it may be difficult for the photographer to approach the digital camera 100, which is installed in the competition area so as not to disturb the athletes, to operate the main unit to change settings or adjust the composition of the camera.

Therefore, in preparation for the possibility that the digital camera 100 may get wet and malfunction due to rain during the track event, a rain cover is placed over the digital camera 100 to prevent rain from entering the digital camera 100.

In addition, the intervals between track events in the competition schedule may result in longer wait times.

In the above-described multi-remote shooting of track events using the multiple digital cameras 100, two problems can occur.

The first problem is that each digital camera 100 heats up due to long hours of continuous shooting operation and the sealing of the rain cover attached, as well as direct sunlight on the body of the digital camera 100, resulting in an increase in the body temperature, reaching a critical temperature, and possibly causing problems with shooting.

The second problem is that battery power supply may cause the camera to run out of battery power, which may interrupt the shooting process partway. In this case, depending on the competition schedule, a case may be assumed in which the photographer cannot approach the digital camera 100 to change the battery.

Therefore, to deal with the above-mentioned problems, it may be desirable to be able to remotely turn off the camera frequently when the camera is not performing shooting.

To deal with the above-mentioned problems, it is desirable to be able to remotely turn on the digital camera 100 and start shooting when the track event resumes.

Next, multi-remote shooting control in this proposal will be described.

### Control Screen for Multi-Remote Shooting

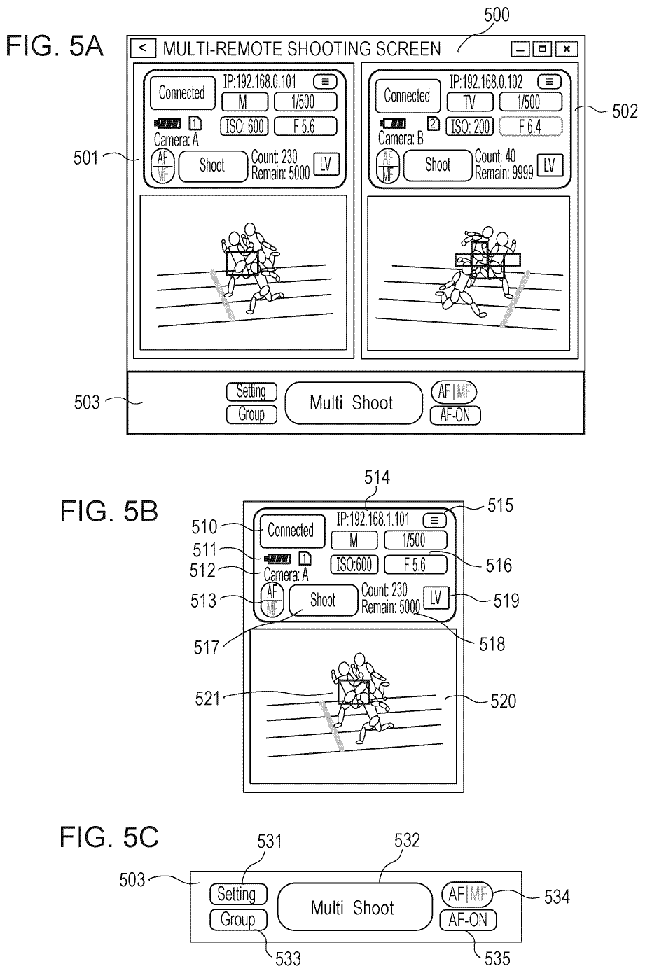

Two digital cameras 100 and the control apparatus 200 are connected, and the control apparatus 200 starts a digital camera control application (a multi-remote app) that runs on the control apparatus 200. FIG. 5A illustrates a screen configuration for performing shooting control of multiple digital cameras 100, the screen configuration being displayed on the display unit 206 of the control apparatus 200.

FIG. 5A is an example of a multi-remote shooting screen 500. The multi-remote shooting screen 500 includes individual camera control components 501 and 502 and a multi-camera control component 503 (hereinafter, the control of multiple cameras is referred to as “multi-camera control”).

The individual camera control component 501 is a control component through which the control apparatus 200 sets settings related to shooting and performs focusing and shooting, for example, to control the corresponding digital camera 100 connected thereto. The individual camera control component 502 is a control component through which the control apparatus 200 controls the second digital camera 100 connected thereto. The multi-camera control component 503 is a control component that controls multiple digital cameras 100 at once. The individual camera control component 501 and the individual camera control component 502, which is for the second digital camera 100, have the same functions. Furthermore, when the connection settings for the third digital camera 100 are registered in the control apparatus 200, another individual camera control component 501 is added as the third individual camera control component to the multi-remote shooting screen 500.

### Configuration of Individual Camera Control Component

FIG. 5B illustrates the configuration of the individual camera control component 501.

The individual camera control component 501 includes an operation component 510, a display component 511, and a name display component 512. The operation component 510 controls the connection status with the digital camera 100. The display component 511 indicates the power status of the digital camera 100 and the status of a recording unit. The name display component 512 is used to recognize the corresponding camera. The individual camera control component 501 also includes a display operation component 513 and a display component 514. The display operation component 513 displays the focus status, auto or manual, and switches the focus setting. The display component 514 indicates the network address of the digital camera 100. The individual camera control component 501 also includes a setting component 515 and a component group 516. The setting component 515 sets various settings to control the corresponding camera. The component group 516 displays the shooting settings of the digital camera 100 and controls changes to the shooting settings. Furthermore, the individual camera control component 501 includes a component 517 that performs remote shooting control (hereinafter referred to as “remote shooting”) on the corresponding digital camera 100. The individual camera control component 501 also includes a display component 518 and a component 519. The display component 518 indicates the number of remaining shots of the digital camera 100 and the number of captured images. The component 519 controls the live view display of the digital camera 100. Furthermore, the individual camera control component 501 includes a remote live display operation component 520 and a display component 521 that indicates the autofocus state.

The photographer checks the focus status, auto or manual, through the display operation component 513 of the individual camera control component 501 illustrated in FIG. 5B, switches the focus setting, and performs remote shooting.

Note that the display form of the display operation component for the focus setting in the remote shooting illustrated in this Example is an example, and it is sufficient for the user to be able to check the set status.

### Configuration of Multi-Camera Control Component

FIG. 5C illustrates the configuration of the multi-camera control component 503.

The multi-camera control component 503 includes components that command multiple digital cameras 100 at once. Specifically, the multi-camera control component 503 includes operation components 531, 532, and 533. The operation component 531 sets and controls shooting parameter settings at once. The operation component 532 issues a multi-remote shooting command. The operation component 533 selects a group when the multi-remote shooting command is issued. Moreover, the multi-camera control component 503 includes a display operation component 534 and an operation component 535. The operation component 535 issues an autofocus command to multiple digital cameras 100 at once. The display operation component 534 indicates a set status, autofocus or a fixed focus, for when the multi-remote shooting command is to be issued.

Note that the display form of the display operation component for the focus setting in the multi-remote shooting illustrated in this Example is an example, and it is sufficient for the user to be able to check the set status.

### Flowchart for Multi-Remote Shooting by Control Apparatus 200

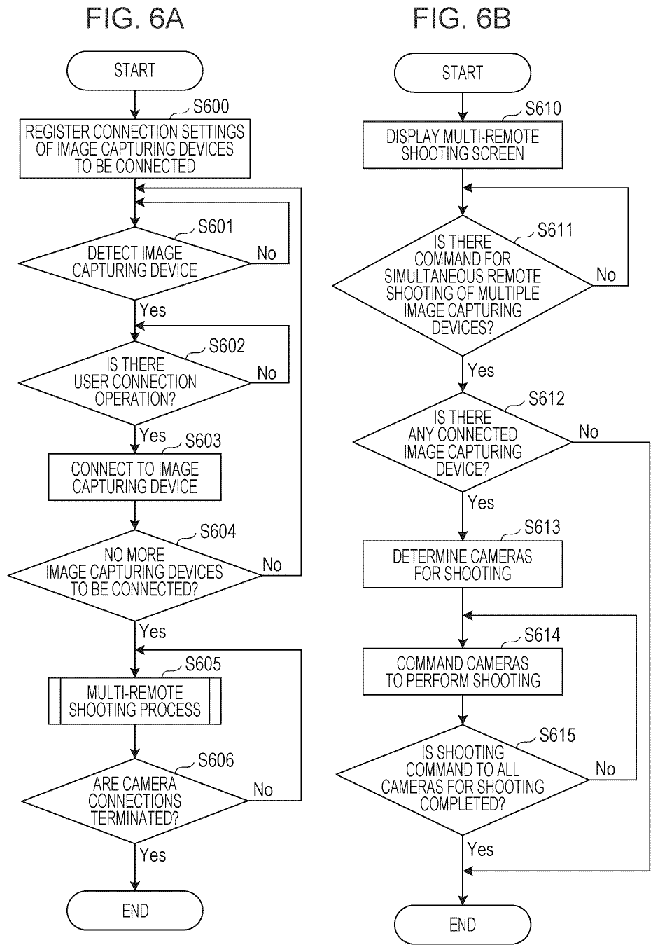

Next, using FIGS. 6A and 6B in the embodiment, flowcharts of a process will be described in which the control apparatus 200 performs a focus drive control process on each digital camera 100 during multi-remote shooting for multiple digital cameras 100.

The flowchart in FIG. 6A indicates a procedure in which the control apparatus 200 is connected to the multiple digital cameras 100 and multi-remote shooting is performed and completed.

The procedure begins when the control apparatus 200 starts up.

In Step S600, the controller 201 registers connection settings of the multiple digital cameras 100 to be connected to the control apparatus 200, and the process proceeds to Step S601.

In Step S601, the controller 201 processes detection of a digital camera 100 and determines whether or not a digital camera 100 is detected. In a case where a digital camera 100 is detected, the process proceeds to Step S602. In a case where no digital camera 100 is detected, Step S601 is repeated.

In Step S602, the controller 201 determines whether the user has made a connecting request. In a case where it is determined that a connecting request has been made, the process proceeds to Step S603. In a case where a connecting request has not been made, Step S602 is repeated.

In Step S603, the controller 201 establishes a connection with the detected digital camera 100 by performing a connecting process on the digital camera 100, and the process proceeds to Step S604.

In Step S604, the controller 201 determines whether there are no second or subsequent digital cameras 100 to be connected that were registered in Step S600 and multi-remote shooting can be started. In a case where multi-remote shooting can be started, the process proceeds to Step S605. In a case where it is determined that multiple digital cameras 100 still remain to be connected, the process returns to Step S601. In Step S605, the controller 201 performs a multi-remote shooting process illustrated in FIG. 6B, and the process proceeds to Step S606.

In Step S606, the controller 201 ends the procedure in a case where it is determined that the connections with the multiple digital cameras 100 are terminated and the multi-remote shooting requested by the user has been completed. In a case where the multi-remote shooting requested by the user has not been completed, the process returns to Step S605.

The flowchart in FIG. 6B illustrates the procedure of the multi-remote shooting process performed for multiple digital cameras 100 by the control apparatus 200.

The procedure begins when the control apparatus 200 establishes connections with multiple digital cameras 100. In Step S610, the controller 201 displays the multi-remote shooting screen illustrated in FIG. 5A on the display unit 206, and the process proceeds to Step S611.

In Step S611, the controller 201 determines whether or not the user has made a multi-remote shooting request for multiple digital cameras 100. In a case where it is determined that a multi-remote shooting request has been made, the process proceeds to Step S612. In a case where it is determined that a multi-remote shooting request has not been made, Step S611 is repeated.

In Step S612, the controller 201 confirms whether or not the registered digital cameras 100 are connected. In a case where the registered digital cameras 100 are connected, the process proceeds to Step S613. In a case where it is determined that the registered digital cameras 100 are disconnected, the multi-remote shooting process is terminated.

In Step S613, the controller 201 confirms the status of digital cameras 100, which belong to a group that performs shooting or can perform remote shooting, among the connected multiple digital cameras 100. The controller 201 then determines the digital cameras for remote shooting, and the process proceeds to Step S614.

In Step S614, the controller 201 performs the multi-remote shooting process, and the process proceeds to Step S615.

In Step S615, the controller 201 determines whether or not the multi-remote shooting command for the digital cameras 100, which perform shooting, determined in Step S613 has been completed. In a case where the multi-remote shooting command has been completed, the controller 201 ends the multi-remote shooting. In a case where the multi-remote shooting command has not been completed, the process returns to Step S614.

### Flowchart of Shooting Process for Digital Camera 100

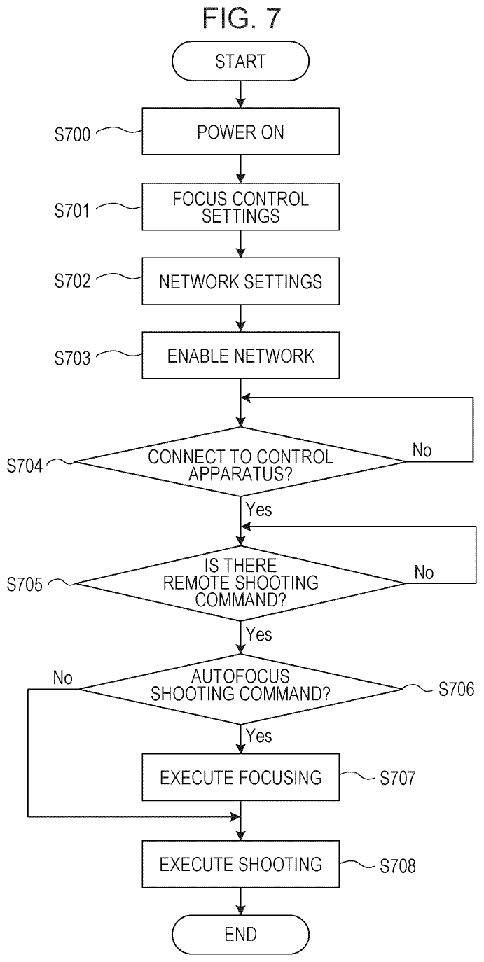

FIG. 7 illustrates a flowchart in which a digital camera 100 receives a command from the connected control apparatus 200 and performs remote shooting in this proposed embodiment.

The flowchart in FIG. 7 begins from the state where the digital camera 100 is arranged at a shooting position.

In Step S700, for example, the user turns on the digital camera 100, and the digital camera 100 is activated and ready to start shooting. The process then proceeds to Step S701.

In Step S701, when receiving the remote shooting command from the control apparatus 200, the controller 101 prepares the lens attached to the digital camera 100 for both autofocus drive and a fixed focus. The process then proceeds to Step S702.

In Step S702, the controller 101 sets network settings for a connection to the control apparatus 200, and the process proceeds to Step S703.

In Step S703, the controller 101 enables the network settings and waits to connect to the control apparatus 200, and the process proceeds to Step S704.

In Step S704, the controller 101 determines whether or not a connecting request from the control apparatus 200 has been received. In a case where a connecting request has been received, the process proceeds to Step S705. In a case where a connecting request has not been received, Step S704 is repeated to confirm a connecting request from the control apparatus 200.

In Step S705, the controller 101 determines whether or not the remote shooting command from the control apparatus 200 has been received. In a case where the remote shooting command has been confirmed, the process proceeds to Step S706. In a case where the remote shooting command has not been received, Step S705 is repeated to confirm the remote shooting command from the control apparatus 200.

In Step S706, the controller 101 confirms a focus drive control command for shooting, the focus drive control command being received together with the remote shooting command from the control apparatus 200. In a case where shooting is performed using autofocus, the process proceeds to Step S707. In a case where shooting is performed with a fixed focus, the process proceeds to Step S708. In Step S707, the controller 101 executes the process of focusing on the subject, and the process proceeds to Step S708.

In Step S708, the digital camera 100 executes shooting and ends the procedure.

### Configuration of Top Screen

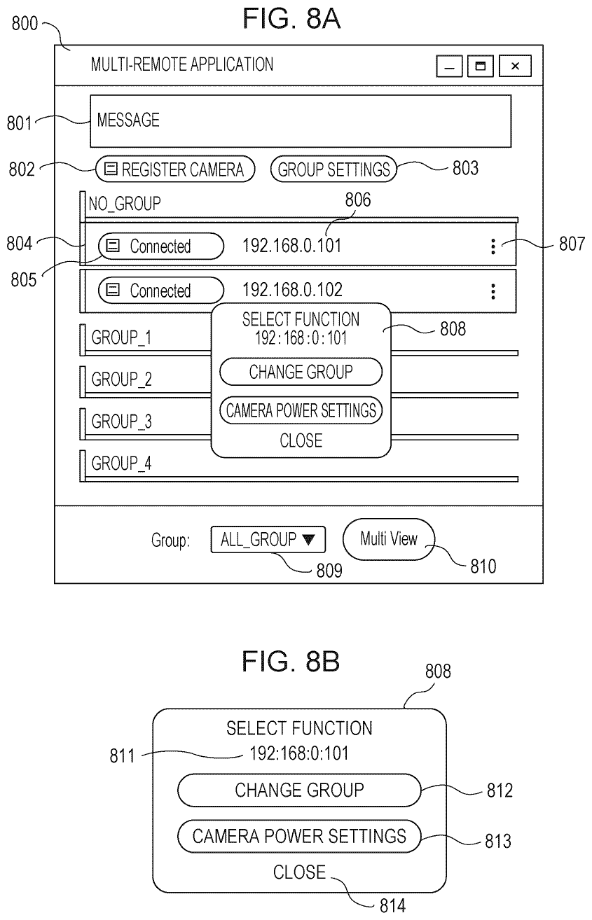

FIG. 8A is a diagram for describing a screen configuration of a multi-remote application displayed on the display unit 206 of the control apparatus 200. FIG. 8A illustrates a top screen 800, which is the entry point to an application that registers cameras, sets group control settings, and sets the functions of each camera in order to perform multi-remote shooting or stand-alone shooting using multiple digital cameras 100.

The top screen 800 of the multi-remote application includes the following display and operation components.

For example, the top screen 800 includes a message display area 801, which displays a message when a digital camera 100 and the control apparatus 200 are connected. The top screen 800 also includes a camera registration operation component 802, which has the function of activating a screen for registering digital cameras 100 as connection targets of the control apparatus 200 and editing the network settings.

The top screen 800 also includes a group edit operation component 803, which has the function of activating a group edit screen for renaming or changing color arrangement of a group of digital cameras 100 to be registered.

The top screen 800 also includes a display area 804, which displays the details of the registered digital camera 100 and through which a group setting status is set.

The top screen 800 also includes a multi-screen operation component 810, which has the function of activating the multi-remote shooting screen, and a group selection-display component 809 for selecting a group of digital cameras 100 to be displayed on the multi-remote shooting screen. Note that the display and operation components included in the top screen 800 are not limited to the above-mentioned examples.

When a digital camera 100 is registered, the connection status of the registered digital camera 100 and an operation component 805 for performing a connection-disconnection operation are displayed in the display area 804, and a label component 806 indicating network information for the registered digital camera 100 is displayed.

The registration status of the digital cameras 100 in FIG. 8A indicates that two digital cameras 100 are registered. Specifically, the example is illustrated in which the first digital camera 112 is assigned an IP address of 192.168.0.101, the second digital camera 113 is assigned an IP address of 192.168.0.102, and the first and second digital cameras 112 and 113 are connected.

Next, a function selection component 807 is arranged on the display area of each registered digital camera 100. When the user operates the function selection component 807, a function selection dialog 808 is displayed. FIG. 8B illustrates the configuration of the function selection dialog 808. The function selection dialog 808 includes an IP address display component 811 indicating the selected digital camera 100, a function selection button 812, a camera power setting button 813, and an operation component 814 for closing the function selection dialog 808.

When the user selects the camera power setting button 813, a camera power setting screen 900 illustrated in FIG. 9A is displayed.

### Digital Camera Power Control Screen

In a case where the control apparatus 200 and digital cameras 100 are connected, the power of each digital camera 100 can be turned off and on remotely via the network. This can be achieved by a camera power control function on the digital camera control application running on the control apparatus 200.

The camera power setting screen 900 illustrated in FIG. 9A is a screen for the control apparatus 200 to perform a power control operation on the digital camera 100 and set settings for the digital camera 100.

The camera power setting screen 900 includes the following components.

The camera power setting screen 900 has a selected camera display operation area 901, where the connection status of the camera selected as a power control target, an operation component for connection and disconnection, and camera information such as an IP address are displayed.

The camera power setting screen 900 has an area 902, which is also referred to as a MAC address display operation component and where the MAC address of the selected camera can be displayed and edited. The MAC address display operation component 902 is an operation component that enables the display and editing of information regarding the MAC address of the digital camera 100 acquired by the control apparatus 200 from the digital camera 100 when the digital camera 100 and the control apparatus 200 are connected.

The camera power setting screen 900 has a WOL setting area 903, where a WOL setting for activating the power of the selected camera is set. Furthermore, the WOL setting area 903 has a WOL enabled selection component 904 to select whether or not to activate the camera using WOL. In the enabling of the WOL setting, the status of the WOL setting, enabled or disabled, is recorded on the multi-remote application of the control apparatus 200, and a command to enable or disable the WOL setting is issued to the connected digital camera 100.

The camera power setting screen 900 has an operation component 905 for transmitting a WOL packet to the camera, which is selected when WOL is enabled, from the control apparatus 200 to activate the camera. The operation component 905 for activating the camera can be operated even in a situation where the digital camera 100 and the control apparatus 200 are not connected.

The camera power setting screen 900 has an operation component 906 for turning off the selected digital camera 100 to transition the selected digital camera 100 into a sleep state (an example of a power-saving state) while the selected digital camera 100 is connected to the control apparatus 200. The operation performed by the operation component 906 is an example of a transition operation.

When the user operates the operation component 906 for turning off the digital camera 100, a message dialog (hereinafter also referred to as “warning display dialog”) 910 with the message content that the digital camera 100 cannot be turned on is displayed. Examples of cases where such message display is performed include, for example, a case where the control apparatus 200 is connected to a digital camera 100 that does not support WOL, a case where the camera to be turned off is on a different network, and a case where the connection status of the digital camera 100 is a wireless connection.

The warning display dialog 910 illustrated in FIG. 9B has a message display area 911 and operation components for determining whether or not to perform a sleep transition. In a case where an operation component 912 for transitioning into a sleep state is selected, the control apparatus 200 instructs the digital camera to transition into the sleep state. In a case where an operation component 913 for not transitioning into the sleep state is selected, the warning display dialog 910 is closed. Note that the message content may be output using other methods. For example, the message content may be presented to the user by sound or vibration indicating a warning. The warning display dialog 910 is an example of notification information.

When the user operates the operation component 906 for turning off the digital camera 100, in a case where WOL is not enabled, a warning display dialog (hereinafter also referred to as “message dialog”) 920 is displayed.

The message dialog 920 illustrated in FIG. 9C has operation components in a message display area 921 for the user to determine whether or not to enable the WOL function. In a case where an operation component 923 for enabling WOL is selected, the control apparatus 200 activates the WOL setting for the digital camera 100 and performs power-off control of the digital camera 100. In a case where an operation component 922 for not enabling WOL is selected, the message dialog 920 is closed. Note that the message dialog 920 is an example of disabled notification information.

The camera power setting screen 900 includes the above-described operation display components.

### Configuration of WOL Packet

To turn on a camera or reset a camera, a WOL packet is transmitted to a connection network as a User Data Protocol (UDP) broadcast command.

FIG. 9D illustrates the configuration of the WOL packet 930.

The WOL packet 930 includes a preamble 931 indicating the start of the packet, a destination MAC address 932, a source MAC address 933, and a WOL type 934. Furthermore, the WOL packet 930 includes a payload 935 of the WOL packet, and a frame check sequence (FCS) 936 for packet error checking. The payload 935 of the WOL packet is constituted by six bytes data of FF-FF-FF-FF-FF-FF indicating the start of the data, and data containing the MAC address of the digital camera 100, which serves as a power control command target, repeated 16 times in succession.

Note that the configuration example of the WOL packet 930 in this Example is merely an example. It is sufficient that the packet be configured such that when a power control target device receives the packet, the packet can be determined to be a power control command to the power control target device.

Note that although the example has been described in which the WOL packet 930 is broadcast via UDP communication, a unicast transmission command specifying the IP address of the digital camera 100 may be issued from the control apparatus 200.

The WOL packet 930 may be transmitted using TCP/IP or other communication protocols that can be received and determined by the digital camera 100 that receives the WOL packet 930.

### Conditions Preventing Remote Power-On of Digital Camera 100

A situation occurs where the power of a digital camera 100 cannot be activated to be in an on state even when a WOL packet is transmitted from the control apparatus 200 to the digital camera 100.

A first condition is a case where the control apparatus 200 is connected to a digital camera 100 that does not have the WOL function. This is because no effective control can be performed on the digital camera 100 even when the digital camera 100 receives a WOL packet.

A second condition is a case where the control apparatus 200 is connected to a network interface, which does not have the WOL function, of the digital camera 100. The communication unit 111 or the communication unit 112 is a wireless network interface, and in many cases, the digital camera 100 does not have the WOL function to avoid power consumption when the power is off.

Furthermore, since the WOL packet 930 often uses a transport layer data transmission method, similarly, there may be cases where the communication unit 111 or 112 does not have the WOL function if the network interface does not support it.

A third condition is a case where the control apparatus 200 and the digital camera 100 are on different networks. In setting the IP address and subnet mask range of the network, in a case where the control apparatus 200 and the digital camera 100 are located on different networks, HTTP communication over TCP/IP is possible. However, there may be a case where the WOL packet 930, which is broadcast via UDP to the network, cannot reach the digital camera 100 from the control apparatus 200 due to the routing or gateway settings of intermediate network devices.

In this Example, before turning the digital camera 100 off, the control apparatus 200 remotely determines the multiple situations and conditions listed above that prevent the digital camera 100 from being turned on. The control apparatus 200 displays a warning to the user in accordance with the determination result, so that the problem of being unable to turn on the digital camera 100 remotely can be avoided in advance. The situations and conditions that prevent the digital camera 100 from being turned on are examples of recovery availability information indicating whether a WOL packet can cause the digital camera 100 to recover from a power-saving state to an active state.

### Power Control Sequence for Digital Camera 100

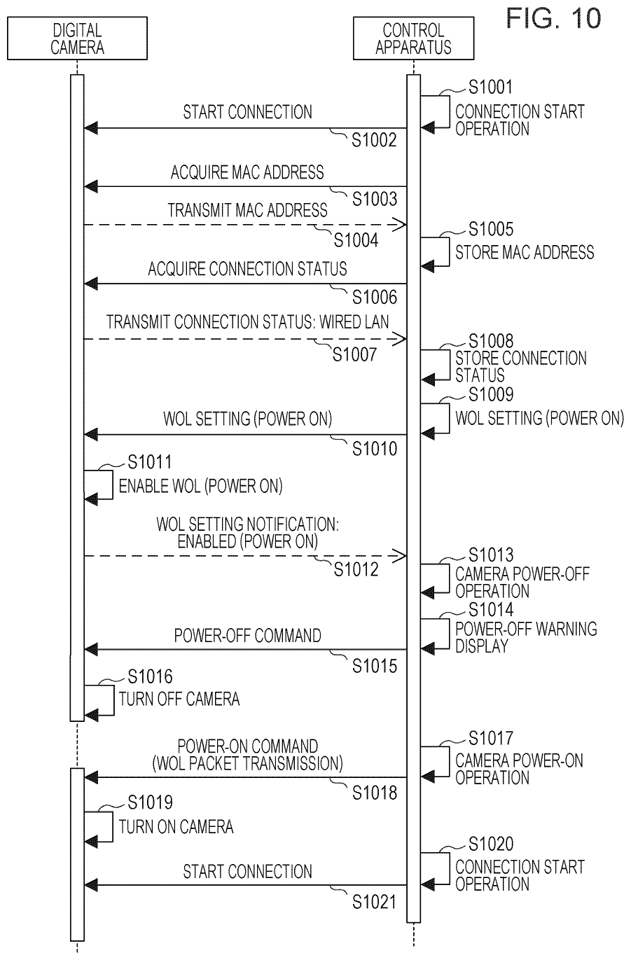

FIG. 10 illustrates a power control processing sequence in which the control apparatus 200 turns a digital camera 100 off and then on and reconnects to the digital camera 100.

The sequence begins when the digital camera 100 and the control apparatus 200 are turned on and are ready for connection.

In Sequence S1001, the user of the control apparatus 200 performs a connecting request operation for the digital camera 100.

In Sequence S1002, the control apparatus 200 transmits a connection start request command to the digital camera 100 to establish a connection with the digital camera 100. When establishing a connection, the control apparatus 200 acquires function information regarding the digital camera 100 and confirms whether or not the digital camera 100 has the WOL function.

In Sequence S1003, the control apparatus 200 requests the MAC address of the digital camera 100.

In Sequence S1004, the digital camera 100 transmits its MAC address to the control apparatus 200.

In Sequence S1005, the control apparatus 200 records, in the non-volatile memory 203, the MAC address received from the digital camera 100.

In Sequence S1006, the control apparatus 200 requests information regarding the connection status of the digital camera 100. The information regarding the connection status is information indicating whether the connection is made wirelessly or via a wired LAN (namely, a wired connection).

In Sequence S1007, the digital camera 100 transmits information regarding its connection status to the control apparatus 200.

In Sequence S1008, the control apparatus 200 records, in the non-volatile memory 203, the information regarding the connection status received from the digital camera 100.

In the example of this sequence, assume that WOL setting information is set to “turn on the camera”. In Sequence S1009, the control apparatus 200 determines the WOL setting information in a case where the WOL setting set by the user is confirmed and the user has performed a request operation, or by confirming the user's WOL setting information stored in the non-volatile memory 203.

In Sequence S1010, the control apparatus 200 transmits the WOL setting information determined by the user to the digital camera 100.

In Sequence S1011, the digital camera 100 stores, in the non-volatile memory 103, the WOL setting information received from the control apparatus 200.

In Sequence S1012, the digital camera 100 notifies the control apparatus 200 of the WOL setting indicating that the WOL setting information received from the control apparatus 200 is reflected and stored in the digital camera 100.

In Sequence S1013, the control apparatus 200 accepts a power-off operation performed for the digital camera 100 by the user of the control apparatus 200.

In Sequence S1014, the control apparatus 200 determines the connection status and network status of the digital camera 100 and then determines whether or not the digital camera 100 can be turned on remotely from the control apparatus 200 and whether or not to display a warning. The control apparatus 200 displays a warning in accordance with the determination result.

In Sequence S1015, the control apparatus 200 transmits a power-off command to the digital camera 100.

In Sequence S1016, in a case where the WOL setting information stored in the non-volatile memory 103 is “turn on the camera”, the digital camera 100 performs a process in response to the power-off command received from the control apparatus 200. In this case, the digital camera 100 sets the communication unit 113 such that the digital camera 100 can be activated in response to the received WOL packet 930, and the digital camera 100 is turned off.

In Sequence S1017, the control apparatus 200 accepts a power-on operation performed for the digital camera 100 by the user of the control apparatus 200.

In Sequence S1018, the control apparatus 200 transmits the WOL packet 930, as a power-on command to the digital camera 100, to the digital camera 100.

In Step S1019, the communication unit 113, which controls wired LAN communication of the digital camera 100 having received the WOL packet 930 from the control apparatus 200, inputs an interrupt signal into the controller 101 of the digital camera 100. Thereafter, the digital camera 100 performs a power activation process to enter the power-on state.

In Sequence S1020, similarly to Sequence S1001, the user of the control apparatus 200 performs a connecting request operation for the digital camera 100. Note that the camera power-on operation in Sequence S1017 may be recorded to automatically start a reconnection between the control apparatus 200 and the digital camera 100 in Sequence S1020.

In Sequence S1021, similarly to Sequence S1002, the control apparatus 200 transmits a connection start request command to the digital camera 100 to establish a connection with the digital camera 100.

In FIG. 10, the example has been described in which the control apparatus 200 requests the information regarding the connection status of the digital camera 100 in Sequence S1006. However, the timing at which the information regarding the connection status is requested is not limited to the example. For example, the control apparatus 200 may request the information regarding the connection status from the digital camera 100 before determining the connection status in Sequence S1014 or may request the information regarding the connection status multiple times.

### Warning Display Flowchart When Power is Off

Through the camera power setting screen 900 illustrated in FIG. 9A, the control apparatus 200 determines the network status of the digital camera 100 when turning off the digital camera 100 in response to a power-off operation performed by the user. The control apparatus 200 determines that the digital camera 100 is in a state in which the digital camera 100 cannot be turned on, and performs a process to warn the user of the control apparatus 200 not to turn off the digital camera 100.

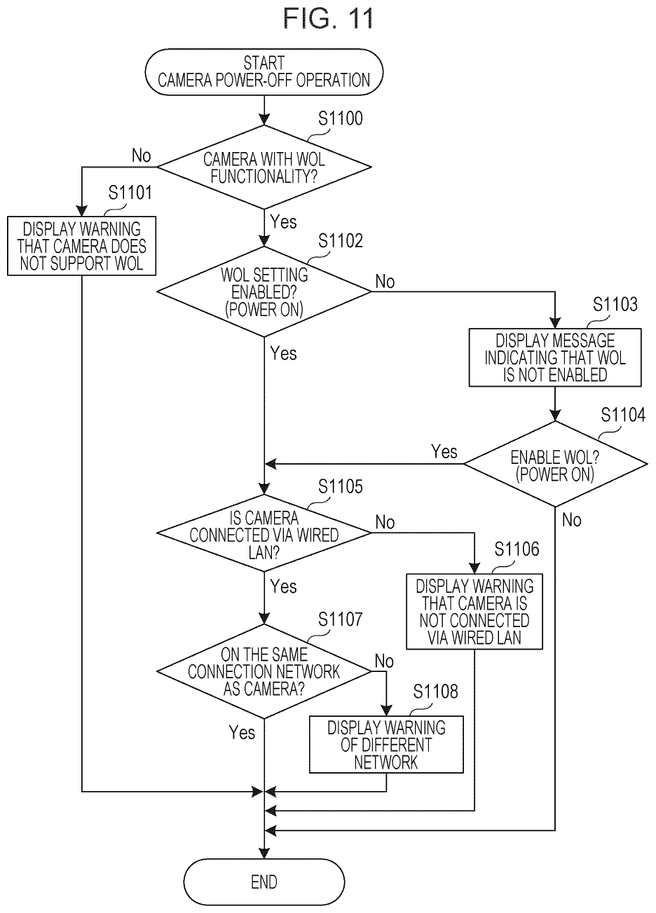

FIG. 11 illustrates a flowchart in which the above-mentioned control apparatus 200 performs warning display control.

The procedure begins when the user of the control apparatus 200 performs a camera power-off operation.

In Step S1100, the control apparatus 200 determines the type of the connected digital camera 100 and determines whether or not the connected digital camera 100 has the WOL function and can be remotely turned on by receiving the WOL packet 930 transmitted thereto. If possible, the process proceeds to Step S1102. If not possible, the process proceeds to Step S1101.

In Step S1101, since the connected digital camera 100 does not have a power-on function based on WOL, the warning display dialog 910, with a message indicating that the connected digital camera 100 does not have a power-on function based on WOL, is displayed on the camera power setting screen 900, and the procedure ends.

In Step S1102, the control apparatus 200 determines whether or not a WOL enabled setting has been set by the user. In a case where the user's WOL setting information stored in the non-volatile memory 203 is enabled, the process proceeds to Step S1105. In a case where the user's WOL setting information stored in the non-volatile memory 203 is disabled, the process proceeds to Step S1103.

In Step S1103, the control apparatus 200 displays the message dialog 920 to the user, with a message indicating that WOL is not enabled, and the process proceeds to Step S1104.

In Step S1104, in a case where the user has selected the operation component 923 for enabling WOL on the displayed message dialog 920, the process proceeds to Step S1105. In a case where the user has selected the operation component 922, the procedure ends.

In Step S1105, it is determined whether or not the digital camera 100 is connected to the control apparatus 200 via a wired LAN, which is a network interface that can receive WOL packets and turn on the digital camera 100. In a case where the digital camera 100 is connected to the control apparatus 200 via a wired LAN, the process proceeds to Step S1107. In a case where the digital camera 100 is connected to the control apparatus 200 via a network interface other than wired LA Ns, the process proceeds to Step S1106.

In Step S1106, the warning display dialog 910, with a message indicating that the digital camera 100 connected to the control apparatus 200 cannot be turned on using WOL because the digital camera 100 is not connected via a wired LAN, is displayed on the camera power setting screen 900, and the procedure ends.

In Step S1107, it is determined whether or not the control apparatus 200 and the digital camera 100 connected thereto are on the same network so that WOL packets can be received. In a case where the control apparatus 200 and the digital camera 100 connected thereto are on the same network, the procedure ends. In a case where the control apparatus 200 and the digital camera 100 connected thereto are not on the same network, the process proceeds to Step S1108.

In Step S1108, the warning display dialog 910, with a message indicating that the digital camera 100 cannot be turned on using WOL because the control apparatus 200 and the digital camera 100 connected thereto are not on the same network, is displayed on the camera power setting screen 900, and the procedure ends.

### Supplementary Information regarding Embodiment

In the above-described example, power-off control performed on the digital camera 100 by the control apparatus 200 and the activation of the camera using the WOL packet 930 are requested for a single digital camera 100. However, similar control may be performed in a case where multiple digital cameras 100 to be connected are commanded at once.

### Second Embodiment

In a second embodiment, an implementation method will be described in which in multi-remote shooting, the control apparatus 200 remotely transmits the WOL packet 930 to a digital camera 100 that has entered an error state, and the digital camera 100 resets its own power to recover. Furthermore, the second embodiment also indicates implementation details in which the control apparatus 200 determines settings and conditions that prevent the digital camera 100 from being reset and displays warnings and messages to the user.

### Power Reset for Digital Camera 100

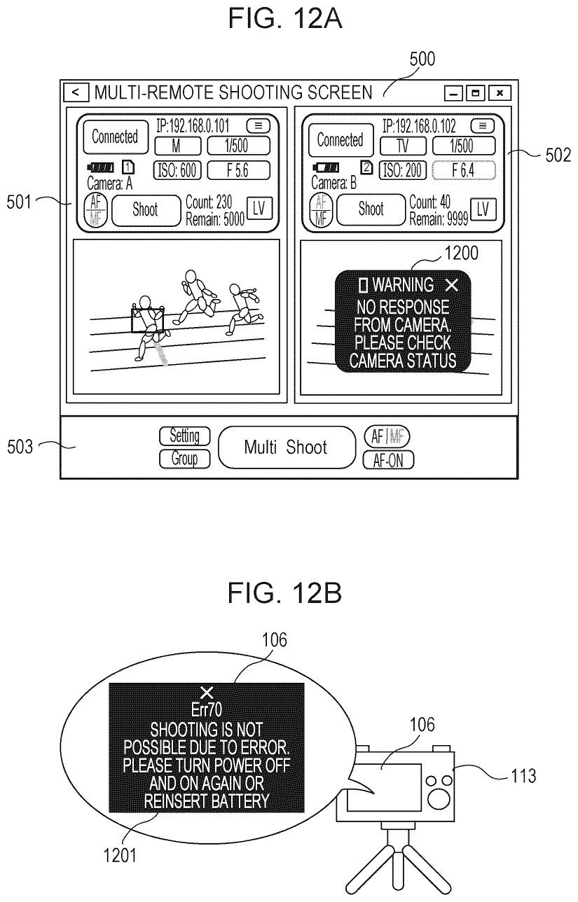

FIG. 12A illustrates the multi-remote shooting screen running on the control apparatus 200 during multi-remote shooting in a case where the multiple digital cameras 100 are connected to the control apparatus 200, as also illustrated in FIG. 5A.

During multi-remote shooting performed by multiple digital cameras 100, a digital camera 100 among the digital cameras 100 may enter an error state due to occurrence of a malfunction, which may result in a situation where the main unit of the digital camera 100 cannot be operated and the digital camera 100 cannot be controlled by the control apparatus 200 via communication. This may result in a situation where the digital camera 100 cannot be controlled remotely.

In FIG. 12B, in a situation where the digital camera 100 has entered an error state, the display unit 106 of the digital camera 100 displays, as an error message to the user, an error number and a message. In the example illustrated in FIG. 12B, the message is “Shooting is not possible due to an error. Please turn the power off and on again or reinsert the battery”; however, the message is not limited to this example. At the same time, as illustrated in FIG. 12A, the control apparatus 200 determines that there is a problem in communication with the digital camera 100. On the multi-remote shooting screen 500, a warning display message dialog 1200 is displayed on the individual camera control component 502 of the digital camera 100 in which an error has occurred.

In a case where the above-described situation occurs, the digital camera 100 cannot be restored to normal operation unless the user turns the digital camera 100 off and on again by operating the main unit of the digital camera 100 or reinserts the battery to perform a reset operation on the digital camera 100. In a case where an error occurs in the digital camera 100 in the middle of an athletics competition during multi-remote shooting as in this Example, the user cannot approach the digital camera 100 to operate its main unit and turn off the digital camera 100 or reinsert the battery to reset the digital camera 100.

An Example will thus be illustrated. In this Example, to reset the digital camera 100 in which an error has occurred, the control apparatus 200 transmits the WOL packet 930 to the digital camera 100, and the digital camera 100 that has received the WOL packet 930 resets itself and recovers from the error state. Hereinafter, the reset of the digital camera 100 using WOL will be referred to as WOL reset.

Since the WOL packet 930 is used to perform reset control of the digital camera 100 in this Example, “conditions that prevent remote reset control of the digital camera 100” are substantially the same as those indicated in a First Example. The conditions indicated in the First Example in this case are “conditions that prevent remote power-on of the digital camera 100”.

### Digital Camera Power Control Screen

In a case where the control apparatus 200 and a digital camera 100 are connected, the control apparatus 200 can reset the digital camera 100 remotely via a network. This function can be achieved by the camera power control function on the digital camera control application running on the control apparatus 200.

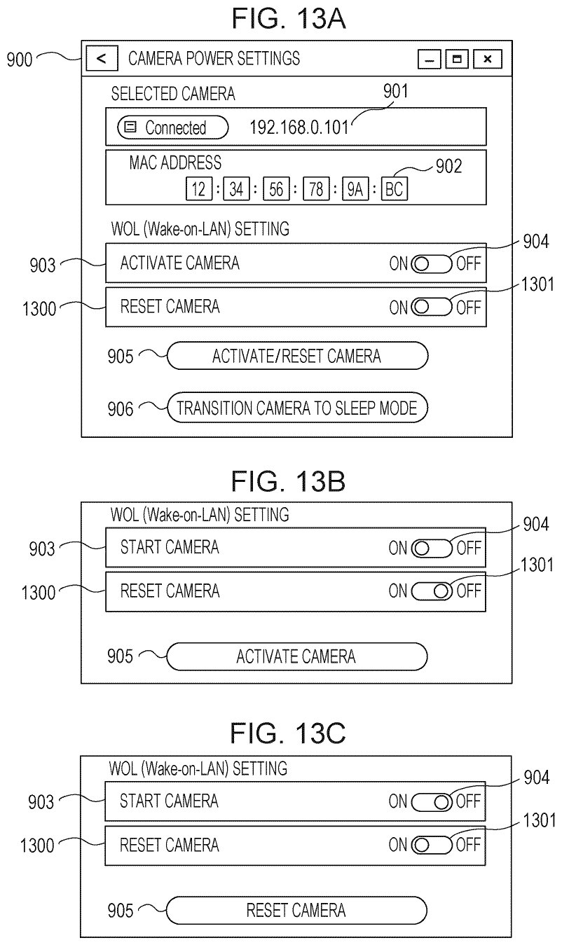

FIG. 13A illustrates the camera power setting screen 900 as also illustrated in FIG. 9A. The camera power setting screen 900 is a screen through which the control apparatus 200 performs a power control operation on the digital camera 100 and sets settings and reset settings for the digital camera 100 in a case where the reset function is enabled for the digital camera 100.

In a Second Example, a power control screen for the digital camera 100 is obtained by adding the following components to the camera power setting screen 900 indicated in the First Example and is configured in a form in which the control and display are changed.

The power control screen has a WOL reset setting area 1300 for setting a WOL reset setting to reset the selected camera and has a WOL reset enabled selection component 1301 for choosing whether or not to reset the camera using WOL. In the enabling of the WOL reset setting, the status of the WOL reset setting, enabled or disabled, is recorded on the multi-remote application of the control apparatus 200, and a command to enable or disable the WOL reset setting is issued to the connected digital camera 100.

The power control screen has the operation component 905 for transmitting a WOL packet to the camera, which is selected when the WOL setting or WOL reset setting is enabled, from the control apparatus 200 to activate the camera. The operation component 905 for activating or resetting the camera can be operated even in a situation where the digital camera 100 is turned off or in an error state and no connection has been established with the control apparatus 200.

The operation performed when the WOL packet 930 is transmitted to the digital camera 100 varies in accordance with the enabled-disabled status of the WOL setting or WOL reset setting, and thus the label indicating the function is changed in accordance with the setting.

When the user operates the WOL reset enabled selection component 1301 for performing WOL reset on the digital camera 100, a message dialog 910 with a message indicating that WOL reset cannot be performed on the digital camera 100 is displayed. Whether or not to display the message dialog 910 is determined based on the result of the determination of “conditions that prevent remote reset control of the digital camera 100”.

The WOL setting for turning on the digital camera 100 and the WOL reset setting for performing reset control of the digital camera 100 are compatible, and the screen configuration for the enabled-disabled status of the WOL setting and WOL reset setting will be illustrated.

In a situation in which the WOL setting is enabled and the WOL reset setting is disabled, in a case where the label indicating the function is “activate the camera”, the WOL enabled selection component 904, the WOL reset enabled selection component 1301, and the operation component 905 are displayed as in FIG. 13B.

In a situation in which the WOL setting is disabled and the WOL reset setting is enabled, in a case where the label indicating the function is “reset the camera”, the WOL enabled selection component 904, the WOL reset enabled selection component 1301, and the operation component 905 are displayed as in FIG. 13C.

The camera power setting screen 900 includes the above-described operation display components.

### Reset Control Sequence for Digital Camera 100

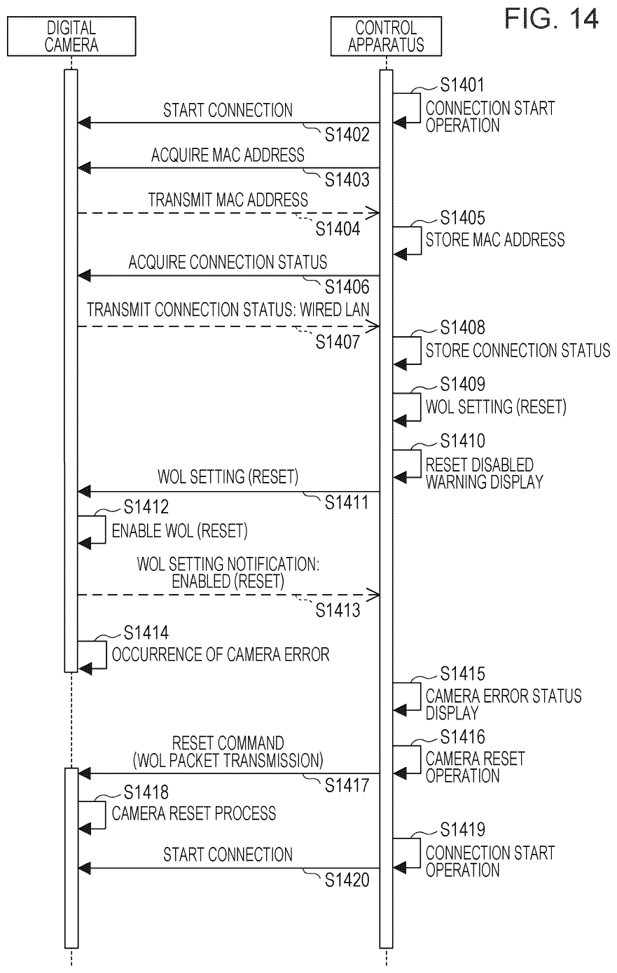

FIG. 14 illustrates a reset control processing sequence in which an error occurs in a digital camera 100 and the control apparatus 200 resets the digital camera 100 and then reconnects to the digital camera 100.

The sequence begins when the digital camera 100 and the control apparatus 200 are turned on and are ready for connection.

In Sequence S1401, the user of the control apparatus 200 performs a connecting request operation for the digital camera 100.

In Sequence S1402, the control apparatus 200 transmits a connection start request command to the digital camera 100 to establish a connection with the digital camera 100. When establishing a connection, the control apparatus 200 acquires function information regarding the digital camera 100 and confirms whether or not the digital camera 100 has the WOL reset function.

In Sequence S1403, the control apparatus 200 requests the MAC address of the digital camera 100.

In Sequence S1404, the digital camera 100 transmits its MAC address to the control apparatus 200.

In Sequence S1405, the control apparatus 200 records, in the non-volatile memory 203, the MAC address received from the digital camera 100.

In Sequence S1406, the control apparatus 200 requests information regarding the connection status of the digital camera 100. The information regarding the connection status is information indicating whether the connection is made wirelessly or via a wired LAN.

In Sequence S1407, the digital camera 100 transmits the information regarding its connection status to the control apparatus 200.

In Sequence S1408, the control apparatus 200 records, in the non-volatile memory 203, the information regarding the connection status received from the digital camera 100.

In the example of this sequence, assume that the WOL rest setting information is set to “perform WOL reset on the camera”.

In Sequence S1409, the control apparatus 200 determines the WOL reset setting information in a case where the WOL reset setting set by the user is confirmed and the user has performed a request operation, or by confirming the user's WOL reset setting information stored in the non-volatile memory 203.

In Sequence S1410, the control apparatus 200 determines the connection status and network status of the digital camera 100 and then determines whether or not the digital camera 100 can be remotely reset from the control apparatus 200 and whether or not to display a warning. Warning display is performed in accordance with the determination result.

In Sequence S1411, the control apparatus 200 transmits the WOL reset setting information determined by the user to the digital camera 100.

In Sequence S1412, the digital camera 100 stores, in the non-volatile memory 103, the WOL reset setting information received from the control apparatus 200.

In Sequence S1413, the digital camera 100 notifies the control apparatus 200 of the WOL reset setting indicating that the WOL reset setting information received from the control apparatus 200 is reflected and stored in the digital camera 100.

In Sequence S1414, an error occurs in the digital camera 100, resulting in the state illustrated in FIG. 12B. The digital camera 100 sets the communication unit 113 to be able to receive WOL packets in a case where the WOL reset setting information stored in the non-volatile memory 103 is “reset the camera” when an error occurs.

In Sequence S1415, the control apparatus 200 receives an error status from the digital camera 100 or determines that the communication with the digital camera 100 is disconnected and no response is received from the digital camera 100. Error status display illustrated in FIG. 12B and indicating that the digital camera 100, a target, has an error is performed.

In Sequence S1416, the user of the control apparatus 200 recognizes that an error has occurred in the digital camera 100, and the control apparatus 200 accepts an operation for resetting the digital camera 100.

In Sequence S1417, the control apparatus 200 transmits a WOL reset command including the WOL packet 930 to the digital camera 100.

In Sequence S1418, the communication unit 113 of the digital camera 100 that has received the WOL packet 930 as a reset command from the control apparatus 200 transmits an interrupt signal to the controller 101 of the digital camera 100. The control apparatus 200 then performs a reset reactivation process on the digital camera 100 to reactivate the digital camera 100.

In Sequence S1419, similarly to Sequence S1401, the user of the control apparatus 200 performs a connecting request operation for the digital camera 100.

In Sequence S1420, similarly to Sequence S1402, the control apparatus 200 transmits a connection start request command to the digital camera 100 to establish a connection with the digital camera 100.

Note that in this sequence, the example has been described in which, when a connection is started between the digital camera 100 and the control apparatus 200, the control apparatus 200 requests the information regarding the connection status of the digital camera 100 in Sequence S1406. However, the control apparatus 200 may request the information regarding the connection status from the digital camera 100 before determining the connection status in Sequence S1410.

### Warning Display Flowchart during WOL Reset Setting

Through the user's setting operation for enabling the WOL reset function, the control apparatus 200 can reset the digital camera 100 when an error occurs in the digital camera 100. However, “conditions that prevent remote reset control of the digital camera 100” are determined, and a process is performed to warn the user of the control apparatus 200 that even if the reset function is enabled, the digital camera 100 is in a situation where the digital camera 100 cannot be reset when an error occurs.

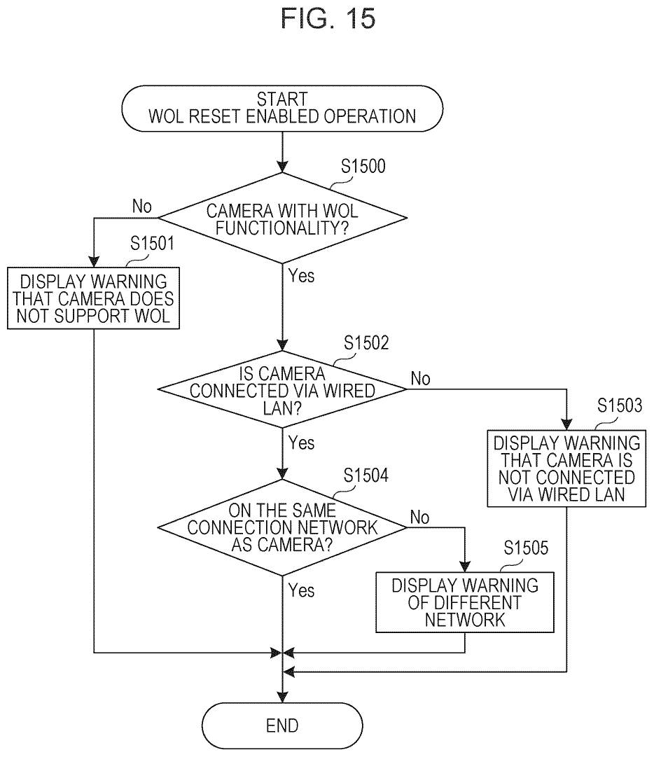

FIG. 15 illustrates a flowchart in which the above-mentioned control apparatus 200 performs warning display control.

The procedure begins when the user of the control apparatus 200 operates to enable the WOL reset function of a digital camera 100 on the camera power setting screen 900 illustrated in FIG. 13A.

In Step S1500, the control apparatus 200 determines the type of the connected digital camera 100 and determines whether or not the connected digital camera 100 has a WOL function and can be remotely turned on by receiving the WOL packet 930 transmitted thereto. If possible, the process proceeds to Step S1502. If not possible, the process proceeds to Step S1501.

In Step S1501, since the connected digital camera 100 does not have the WOL reset function, the warning display dialog 910, with a message indicating that the connected digital camera 100 does not have the WOL reset function, is displayed on the camera power setting screen 900, and the procedure ends.

In Step S1502, it is determined whether the digital camera 100 is connected to the control apparatus 200 via a wired LAN, which is a network interface that receives WOL packets and can reset the camera when an error occurs. In a case where the digital camera 100 is connected to the control apparatus 200 via a wired LAN, the process proceeds to Step S1504. In a case where the digital camera 100 is connected to the control apparatus 200 via a network interface other than wired LA Ns, the process proceeds to Step S1503.

In Step S1503, the warning display dialog 910, with a message indicating that the digital camera 100 connected to the control apparatus 200 cannot be turned on using WOL because the digital camera is not connected via a wired LAN, is displayed on the camera power setting screen 900, and the procedure ends.

In Step S1504, it is determined whether or not the control apparatus 200 and the digital camera 100 connected thereto are on the same network so that WOL packets can be received. In a case where the control apparatus 200 and the digital camera 100 connected thereto are on the same network, the procedure ends. In a case where the control apparatus 200 and the digital camera 100 connected thereto are not on the same network, the process proceeds to Step S1505.

In Step S1505, the warning display dialog 910 is displayed on the camera power setting screen 900 because the control apparatus 200 and the digital camera 100 connected thereto are not on the same network, and the procedure ends. One example of the warning display dialog 910 in this case is a message indicating that, for example, the digital camera 100 cannot be reset in response to the WOL reset command.

### Supplementary Information regarding Embodiment

In the above-described example, camera reset control performed for the digital camera 100 using the WOL packet 930 by the control apparatus 200 is requested for a single digital camera 100. Note that the control apparatus 200 may perform similar control in a case where multiple digital cameras 100 to be connected are commanded at once.

### Other Embodiments

The present disclosure is also realized by executing the following process. That is, software (a program) that realizes the functions of the above-mentioned embodiments is supplied to a system or apparatus via a network or various storage media, and a computer (or a control unit, a microprocessing unit (MPU), for example) of the system or apparatus reads and executes the program code. In this case, the program and the storage medium storing the program constitute an embodiment.

The present disclosure has described details that are based on example embodiments. Some embodiments of the present disclosure are not limited to these specific embodiments, but various embodiments are also included in the present disclosure to the extent that they do not depart from the gist of the present disclosure. Portions of the above-mentioned embodiments may be combined as appropriate.

Each functional unit of each of the above-mentioned embodiments (each modification) may be or does not have to be a separate hardware device. The functions of two or more functional units may be realized by a common hardware device. Each of the functions of a single functional unit may be realized by separate hardware devices. Two or more functions of a single functional unit may be realized by a common hardware device. Each functional unit may be or does not have to be realized by a hardware device such as an application specific IC (ASIC), a field-programmable grid array (FPGA), or a digital signal processing (DSP). For example, the apparatus may have a processor and a memory (storage medium) in which a control program is stored. The functions of at least some of the functional units of the apparatus may then be realized by a processor reading the control program from the memory and executing the control program.

Some embodiments of the present disclosure may also be realized through a process in which a program that realizes one or more functions of the above-mentioned embodiments is supplied to the system or apparatus via a network or storage medium, and one or more processors in the computer of the system or apparatus read and execute the program. The present disclosure can also be realized by a circuit (for example, an ASIC) that realizes one or more functions.

### Configuration 1

A control apparatus that controls an external device, the control apparatus including one or more processors and a memory storing instructions. The instructions, when executed by the one or more processors, cause the control apparatus to acquire recovery availability information indicating whether or not an external device is able to recover from a power-saving state to an active state using a Wake-on-LAN packet, and generate, in a case where a transition operation for causing the external device to transition from the active state to the power-saving state is performed using the Wake-on-LAN packet, notification information indicating that the external device is unable to recover to the active state, based on the recovery availability information acquired from the external device and indicating that the external device is unable to recover to the active state.

### Configuration 2

The control apparatus according to Configuration 1, in which the recovery availability information includes information regarding a connection status indicating whether or not the external device is connected in a wired manner, and the instructions, when executed by the one or more processors, further cause the control apparatus to generate, in a case where the transition operation is performed, the notification information based on the external device not being connected in a wired manner.

### Configuration 3

The control apparatus according to Configuration 1 or 2, in which the recovery availability information includes function information indicating whether or not the external device has a Wake-on-LAN function, and the instructions, when executed by the one or more processors, further cause the control apparatus to generate, in a case where the transition operation is performed, the notification information based on the external device not having the Wake-on-LAN function.

### Configuration 4

The control apparatus according to any one of Configurations 1 to 3, in which the recovery availability information includes information indicating a network status indicating whether or not the external device is located on a network where the control apparatus is located, and the instructions, when executed by the one or more processors, further cause the control apparatus to generate, in a case where the transition operation is performed, the notification information based on the external device being located on a different network from the control apparatus.

### Configuration 5

The control apparatus according to any one of Configurations 1 to 4, in which the instructions, when executed by the one or more processors, further cause the control apparatus to generate, in a case where a setting operation to switch a Wake-on-LAN function of the external device from disabled to enabled is performed, the notification information based on the recovery availability information acquired from the external device and indicating that the external device is unable to recover to the active state.

### Configuration 6

The control apparatus according to Configuration 5, in which the setting operation includes a first setting operation that is used to recover, using the Wake-on-LAN packet, the external device being in the power-saving state, and a second setting operation that is used to reset, using the Wake-on-LAN packet, the external device being in the active state, and the instructions, when executed by the one or more processors, further cause the control apparatus to generate, in a case where the second setting operation is performed, the notification information based on the recovery availability information acquired from the external device and indicating that the external device is unable to recover to the active state.

### Configuration 7

The control apparatus according to any one of Configurations 1 to 6, in which the instructions, when executed by the one or more processors, further cause the control apparatus to generate, in a case where the transition operation is performed and where a Wake-on-LAN function of the external device is set to disabled, disabled notification information indicating that the Wake-on-LAN function of the external device is set to disabled.

### Configuration 8

The control apparatus according to Configuration 7, in which the instructions, when executed by the one or more processors, further cause the control apparatus to generate the disabled notification information including information indicating whether or not to switch the Wake-on-LAN function of the external device from disabled to enabled, based on the recovery availability information acquired from the external device and indicating that the external device is able to recover to the active state.

### Configuration 9

The control apparatus according to any one of Configurations 1 to 8, in which the external device is an image capturing apparatus.

### Configuration 10

The control apparatus according to any one of Configurations 1 to 9, in which the control apparatus is an apparatus that is able to control a plurality of image capturing apparatuses.

### Configuration 11

The control apparatus according to any one of Configurations 1 to 10, further including a display configured to display the notification information.

### Method

A control method for a control apparatus to control an external device, the control method being executed by a computer, and the control method including acquiring recovery availability information indicating whether or not the external device is able to recover from a power-saving state to an active state using a Wake-on-LA N packet, and generating, in a case where a transition operation for causing the external device to transition from the active state to the power-saving state is performed using the WOL packet, notification information indicating that the external device is unable to recover to the active state, based on the recovery availability information acquired from the external device and indicating that the external device is unable to recover to the active state.

### Medium

A non-transitory computer-readable medium storing computer-executable instructions for causing a computer to acquire recovery availability information indicating whether or not the external device is able to recover from a power-saving state to an active state using a Wake-on-LAN packet, and generate, in a case where a transition operation for causing the external device to transition from the active state to the power-saving state is performed using the Wake-on-LAN packet, notification information indicating that the external device is unable to recover to the active state, based on the recovery availability information acquired from the external device and indicating that the external device is unable to recover to the active state.

According to the present disclosure, it becomes possible to recognize, before turning off a digital camera, that the digital camera may be in a situation where the digital camera cannot be turned on remotely using WOL.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-072444, which was filed on Apr. 26, 2024 and which is hereby incorporated by reference herein in its entirety.

What is claimed is:

1. A control apparatus that controls an external device, the control apparatus comprising:
one or more processors; and
a memory storing instructions which, when executed by the one or more processors, cause the control apparatus to:
acquire recovery availability information indicating whether or not an external device is able to recover from a power-saving state to an active state using a Wake-on-LAN packet; and
generate, in a case where a transition operation for causing the external device to transition from the active state to the power-saving state is performed using the Wake-on-LAN packet, notification information indicating that the external device is unable to recover to the active state, based on the recovery availability information acquired from the external device and indicating that the external device is unable to recover to the active state.

2. The control apparatus according to claim 1, wherein
the recovery availability information includes information regarding a connection status indicating whether or not the external device is connected in a wired manner, and
the instructions, when executed by the one or more processors, further cause the control apparatus to generate, in a case where the transition operation is performed, the notification information based on the external device not being connected in a wired manner.

3. The control apparatus according to claim 1, wherein
the recovery availability information includes function information indicating whether or not the external device has a Wake-on-LAN function, and
the instructions, when executed by the one or more processors, further cause the control apparatus to generate, in a case where the transition operation is performed, the notification information based on the external device not having the Wake-on-LAN function.

4. The control apparatus according to claim 1, wherein
the recovery availability information includes information indicating a network status indicating whether or not the external device is located on a network where the control apparatus is located, and
the instructions, when executed by the one or more processors, further cause the control apparatus to generate, in a case where the transition operation is performed, the notification information based on the external device being located on a different network from the control apparatus.

5. The control apparatus according to claim 1, wherein
the instructions, when executed by the one or more processors, further cause the control apparatus to generate, in a case where a setting operation to switch a Wake-on-LAN function of the external device from disabled to enabled is performed, the notification information based on the recovery availability information acquired from the external device and indicating that the external device is unable to recover to the active state.

6. The control apparatus according to claim 5, wherein
the setting operation includes a first setting operation that is used to recover, using the Wake-on-LAN packet, the external device being in the power-saving state, and a second setting operation that is used to reset, using the Wake-on-LA N packet, the external device being in the active state, and
the instructions, when executed by the one or more processors, further cause the control apparatus to generate, in a case where the second setting operation is performed, the notification information based on the recovery availability information acquired from the external device and indicating that the external device is unable to recover to the active state.

7. The control apparatus according to claim 1, wherein
the instructions, when executed by the one or more processors, further cause the control apparatus to generate, in a case where the transition operation is performed and where a Wake-on-LAN function of the external device is set to disabled, disabled notification information indicating that the Wake-on-LAN function of the external device is set to disabled.

8. The control apparatus according to claim 7, wherein
instructions, when executed by the one or more processors, further cause the control apparatus to generate the disabled notification information including information indicating whether or not to switch the Wake-on-LAN function of the external device from disabled to enabled, based on the recovery availability information acquired from the external device and indicating that the external device is able to recover to the active state.

9. The control apparatus according to claim 1,
wherein the external device is an image capturing apparatus.

10. The control apparatus according to claim 1,
wherein the control apparatus is an apparatus that is able to control a plurality of image capturing apparatuses.

11. The control apparatus according to claim 1, further comprising:
a display configured to display the notification information.

12. A control method for a control apparatus to control an external device, the control method being executed by a computer, and the control method comprising:
acquiring recovery availability information indicating whether or not the external device is able to recover from a power-saving state to an active state using a Wake-on-LAN packet; and
generating, in a case where a transition operation for causing the external device to transition from the active state to the power-saving state is performed using the WOL packet, notification information indicating that the external device is unable to recover to the active state, based on the recovery availability information acquired from the external device and indicating that the external device is unable to recover to the active state.

13. A non-transitory computer-readable medium storing computer-executable instructions for causing a computer to:
acquire recovery availability information indicating whether or not the external device is able to recover from a power-saving state to an active state using a Wake-on-LAN packet; and
generate, in a case where a transition operation for causing the external device to transition from the active state to the power-saving state is performed using the Wake-on-LAN packet, notification information indicating that the external device is unable to recover to the active state, based on the recovery availability information acquired from the external device and indicating that the external device is unable to recover to the active state.
